(19) United States
(12) Patent Application Publication
(10) Pub. No.: US 2015/0142500 A1
(43) Pub. Date: May 21, 2015

(54) DECISION SUPPORT SYSTEM FOR INTER-ORGANIZATIONAL INVENTORY TRANSSHIPMENT

(71) Applicant: International Business Machines Corporation, Armonk, NY (US)

(72) Inventors: Faisal Aqlan, Poughkeepsie, NY (US); Warren Boldrin, Montgomery, NY (US); Kristal Diaz-Rojas, Highland, NY (US); Sreekanth Ramakrishnan, Salem, MA (US)

(73) Assignee: International Business Machines Corporation, Armonk, NY (US)

(21) Appl. No.: 14/081,845

(22) Filed: Nov. 15, 2013

(51) Int. Cl. G06Q 10/06; G06Q 10/08

(52) U.S. Cl. CPC G06Q 10/06315; G06Q 10/083
USPC 705/7.25

(57) ABSTRACT

A method for enabling enhanced decision-making when shipping parts between sites within an organization includes receiving a plurality of orders to deliver parts from a first site to a second site. The method determines a shipping option for shipping the parts from the first site to the second site and, for each of the orders, a transportation risk associated with the shipping option. The transportation risk varies in accordance with a probability that the shipping option will result in a delay, and an amount of revenue that will be affected as a result of the delay. The transportation risk for each of the orders is displayed in a matrix. The method further enables a user to modify the shipping option to adjust the position of each transportation risk within the matrix. A corresponding apparatus and computer program product are also disclosed.

### BACKGROUND

1. Field of the Invention

This invention relates to decision support systems for inter-organizational inventory transshipments in complex build-to-order manufacturing environments.

2. Background of the Invention

Recent trends to globalize sourcing, production, and sales along with other environmental and labor-based factors force companies to provide multiple manufacturing and/or service sites located at different geographical locations around the globe. Companies may assign orders to these different sites in a way that fulfills their goals. Order assignment to these sites may be based on different factors, including shipping costs for customers, labor costs, raw material availability, capacity constraints, customer requirements, and the like. In some cases, orders may also be reassigned to different sites or parts may be transported between sites to avoid supply chain risks.

Companies may establish supply sources based on the demand in different geographical areas that purchase/utilize their products. Companies may also attempt to establish raw material suppliers based on where a product is assembled. In many cases, raw material suppliers may be single sourced and/or not geographically co-located. There is also uncertainty with demand forecasting as top level demand may be accurately forecasted but the demand at each geographical level may have a degree of variance, thereby forcing plants to rebalance purchased supply in order to meet overall demand.

Inter-organizational transshipping and order offloading are important decisions made by companies that have multi-site manufacturing systems. These decisions enable a company to be more adaptive and responsive to customer demand. The costs of inter-organizational transportation, however, may be very high and some customer orders may be at risk due to inventory shortage and/or capacity unavailability.

Given the inherent complexities associated with managing numerous operational variables when fulfilling orders, it is essential to make accurate and timely decisions. This is complicated by discrete finite time constraints for revenue recognition. Decisions on where to optimally source an order from multiple global plants may be based on inventory supply position (clear-to-build), plant capacity, time zones, tax advantages, and distribution costs. Decisions may be optimized (maximized or minimized) on any of these dimensions. However, it is imperative that decision makers be aware of impacts to secondary and tertiary variables to evaluate how and where to source orders.

In view of the foregoing, what are needed are apparatus and method to enable enhanced decision-making when fulfilling orders. Such apparatus and methods will ideally enable plant and order managers to quantitatively assess factors in a supply chain to determine how to manage risk, lower costs, as well as provide an improved customer experience and satisfaction.

### SUMMARY

The invention has been developed in response to the present state of the art and, in particular, in response to the problems and needs in the art that have not yet been fully solved by currently available apparatus and methods. Accordingly, apparatus and methods have been developed to enhance decision-making when shipping parts between sites within an organization. The features and advantages of the invention will become more fully apparent from the following description and appended claims, or may be learned by practice of the invention as set forth hereinafter.

Consistent with the foregoing, a method for enabling enhanced decision-making when shipping parts between sites within an organization is disclosed herein. In one embodiment, such a method includes receiving a plurality of orders to deliver parts from a first site to a second site. The method determines a shipping option for shipping the parts from the first site to the second site and, for each of the orders, a transportation risk associated with the shipping option. The transportation risk varies in accordance with a probability that the shipping option will result in a delay, and an amount of revenue that will be affected as a result of the delay. The transportation risk for each of the orders is displayed in a matrix. The position of each transportation risk value within the matrix is based on the probability that the shipping option will result in a delay, and the amount of revenue that will be affected as a result of the delay. The method further enables a user to modify the shipping option to adjust the position of each transportation risk within the matrix.

A corresponding apparatus and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a computing system in which various components of an apparatus and method in accordance with the invention may be implemented;

FIG. 2 is a high-level block diagram showing a multi-plant organization with order offload and inventory transshipment;

FIG. 3 is a process flow diagram showing a framework for inter-organizational inventory transshipment;

FIG. 4 is a high-level block diagram showing an analytic hierarchy process (AHP) for order prioritization;

FIG. 5 is a process flow diagram showing a framework for estimating shipping cost for an order;

FIG. 6 is a high-level block diagram showing an architecture for an interplant transshipment tool in accordance with the invention;

FIG. 7 shows one example of a graphical user interface for inputting data into the interplant transshipment tool;

FIG. 8 shows one example of a graphical user interface for outputting data from the interplant transshipment tool; and

FIG. 9 shows one example of a matrix for displaying transportation risk for one or more orders in a shipment, as well as an overall transportation risk score for the one or more orders.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As will be appreciated by one skilled in the art, the present invention may be embodied as an apparatus, system, method, or computer program product. Furthermore, the present invention may take the form of a hardware embodiment, a software embodiment (including firmware, resident software, microcode, etc.) configured to operate hardware, or an embodiment combining software and hardware. Furthermore, the present invention may take the form of a computer-usable storage medium embodied in any tangible medium of expression having computer-usable program code stored therein.

Any combination of one or more computer-usable or computer-readable storage medium(s) may be utilized to store the computer program product. The computer-usable or computer-readable storage medium may be, for example but not limited to, an electronic, magnetic, optical, electromagnetic, infrared, or semiconductor system, apparatus, or device. More specific examples (a non-exhaustive list) of the computer-readable storage medium may include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CDROM), an optical storage device, or a magnetic storage device. In the context of this document, a computer-usable or computer-readable storage medium may be any medium that can contain, store, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like, conventional procedural programming languages such as the “C” programming language, scripting languages such as JavaScript, or similar programming languages. Computer program code for implementing the invention may also be written in a low-level programming language such as assembly language.

Embodiments of the invention may be described below with reference to flowchart illustrations and/or block diagrams of methods, apparatus, systems, and computer program products. It will be understood that each block of the flowchart illustrations and/or block diagrams, and combinations of blocks in the flowchart illustrations and/or block diagrams, may be implemented by computer program instructions or code. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be stored in a computer-readable storage medium that can direct a computer or other programmable data processing apparatus to function in a particular manner, such that the instructions stored in the computer-readable storage medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

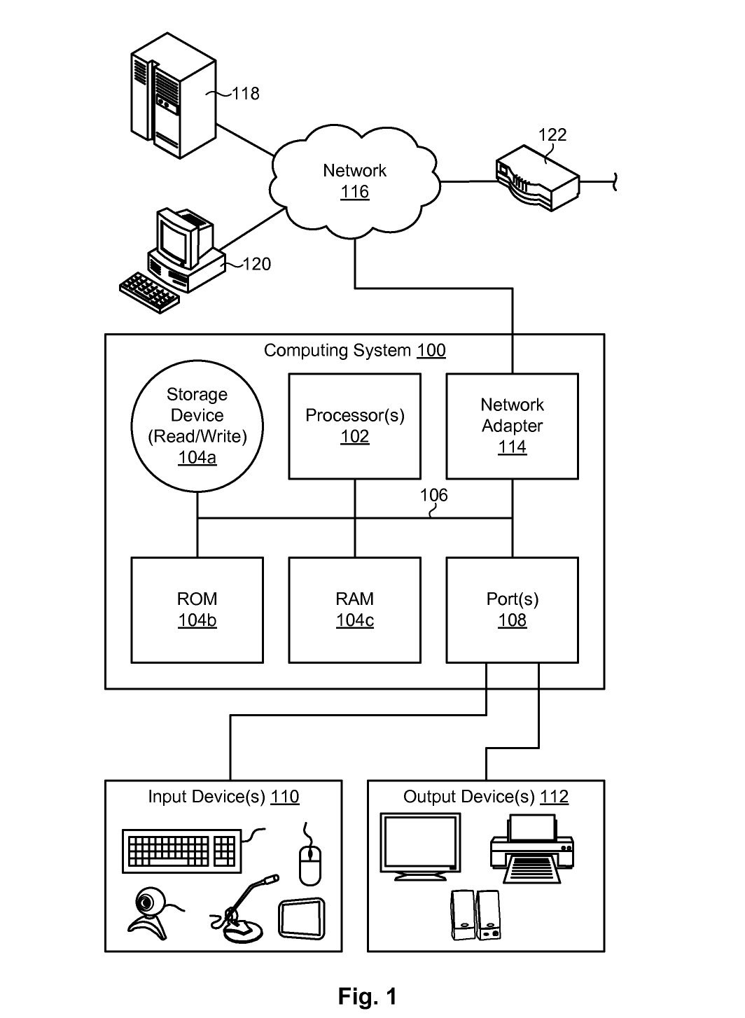

Referring to FIG. 1, one example of a computing system 100 is illustrated. The computing system 100 is presented to show one example of an environment where various components of an apparatus and method in accordance with the invention may be implemented. The computing system 100 is presented only by way of example and is not intended to be limiting. Indeed, the apparatus and methods disclosed herein may be applicable to a wide variety of different computing systems in addition to the computing system 100 shown. The apparatus and methods disclosed herein may also potentially be distributed across multiple computing systems 100.

As shown, the computing system 100 includes at least one processor 102 and may include more than one processor 102. The processor 102 may be operably connected to a memory 104. The memory 104 may include one or more non-volatile storage devices such as hard drives 104a, solid state drives 104a, CD-ROM drives 104a, DVD-ROM drives 104a, tape drives 104a, or the like. The memory 104 may also include non-volatile memory such as a read-only memory 104b (e.g., ROM, EPROM, EEPROM, and/or Flash ROM) or volatile memory such as a random access memory 104c (RAM or operational memory). A bus 106, or plurality of buses 106, may interconnect the processor 102, memory devices 104, and other devices to enable data and/or instructions to pass therebetween.

To enable communication with external systems or devices, the computing system 100 may include one or more ports 108. Such ports 108 may be embodied as wired ports 108 (e.g., USB ports, serial ports, Firewire ports, SCSI ports, parallel ports, etc.) or wireless ports 108 (e.g., Bluetooth, IrDA, etc.). The ports 108 may enable communication with one or more input devices 110 (e.g., keyboards, mice, touchscreens, cameras, microphones, scanners, storage devices, etc.) and output devices 112 (e.g., displays, monitors, speakers, printers, storage devices, etc.). The ports 108 may also enable communication with other computing systems 100.

In certain embodiments, the computing system 100 includes a network adapter 114 to connect the computing system 100 to a network 116, such as a LAN, WAN, or the Internet. Such a network 116 may enable the computing system 100 to connect to one or more servers 118, workstations 120, personal computers 120, mobile computing devices, or other devices. The network 116 may also enable the computing system 100 to connect to another network by way of a router 122 or other device 122. Such a router 122 may allow the computing system 100 to communicate with servers, workstations, personal computers, or other devices located on different networks.

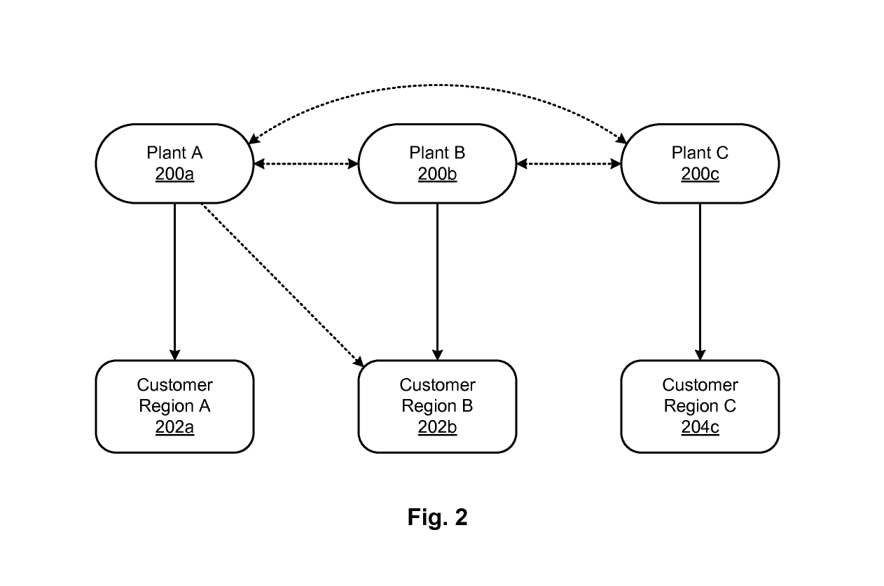

Referring to FIG. 2, a high-level block diagram showing a multi-plant organization with order offload and inventory transshipment is illustrated. Given a set of manufacturing sites 200a-c for a company in different geographical locations, customer orders may be allocated to different sites 200a-c based on cost and planning factors. In certain cases, customer regions 202a-c may be established and assigned to the different manufacturing sites 200a-c. When needed, orders may be offloaded and/or parts may be transported from one site 200 to another 200 (as shown by the dashed lines extending between blocks 200a-c) to avoid or minimize supply and demand risks.

In certain embodiments, a customer order may include one or more of the following: order quantity, order type, order configuration, order destination, and ship date. In certain cases, a manufacturing site may be unable to fulfill a customer order due to raw material shortage, capacity limitation, time limitations, and/or customer requirements. When a raw material shortage arises, a site 200 may obtain parts from a sister site 200 or an external supplier. When other issues (i.e., capacity, time, customer requirements, etc.) arise, a site 200 may offload an order to a sister site 200 that has the ability to fulfill the order, as shown by the dashed line extending between block 200a and block 202b.

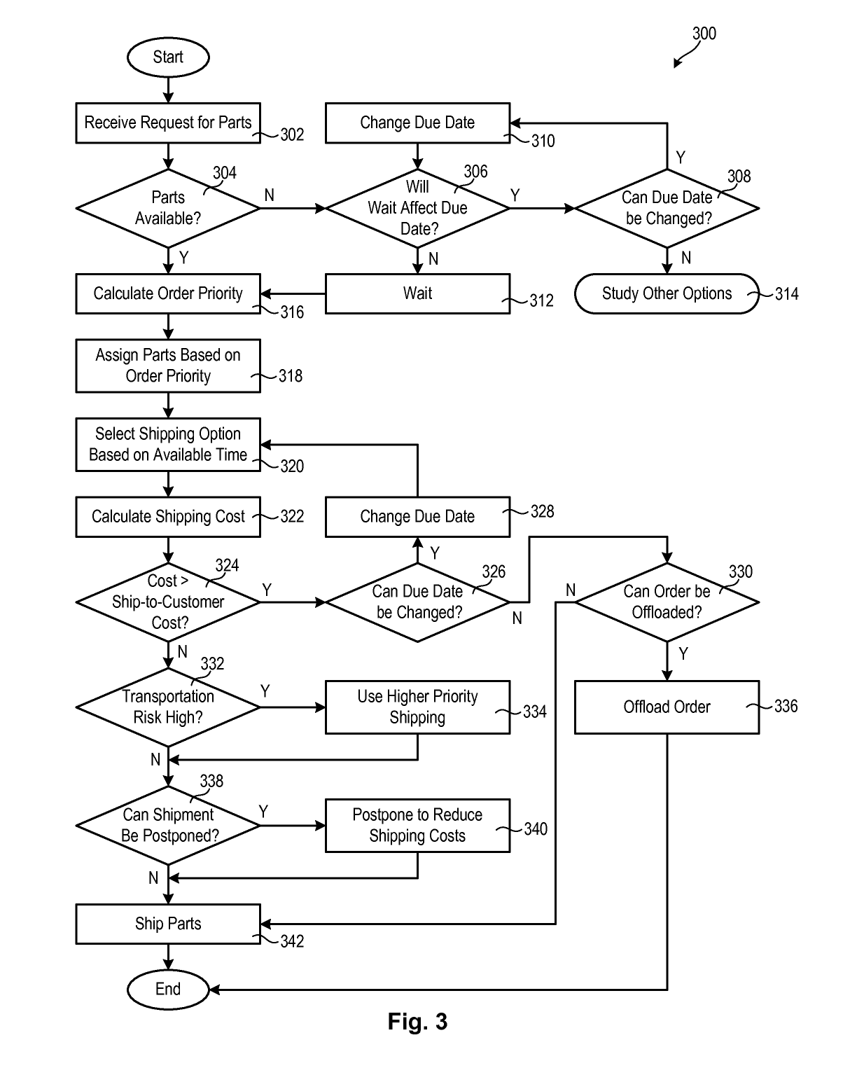

Referring to FIG. 3, a process flow diagram showing a framework 300 for inter-organizational inventory transshipment as a way to mitigate material shortage in supply chains is illustrated. When a manufacturing site 200 does not have sufficient raw materials to fulfill a customer order, the site 200 may send a request for parts to another site 200. Upon receiving 302 the request, the site 200 checks 304 its inventory availability. If the requested parts are not available and an order due date can be maintained (as determined at step 306), the request may be postponed 312 until parts are available. However, if postponement will affect the due date of the order (as determined at step 306) and the due date can be changed (as determined at step 308), the due date may be changed 310, such as by negotiating a change with a customer.

In complex build-to-order manufacturing environments, orders may be treated differently since some orders may be more important than others. Thus, the framework 300 may prioritize 316 orders before assigning 318 parts. An order with higher priority may be allocated parts 318 first in cases where there are a limited number of parts compared to orders. A cheapest shipping option for parts may then be selected 320 by comparing available time for shipping to transportation time for the shipping option. Shipping costs may be calculated 322 based on the chosen shipping option.

The cost to ship parts between sites may then be compared 324 to a cost to ship an order directly to a customer from another site 200. If the cost to ship parts between sites 200 is greater than the cost to ship an order directly to a customer from another site 200, a decision may be made to offload 336 the order, change the due date 328, or ship the parts 342, depending on the outcome of decision steps 326, 330. A transportation delay risk may also be taken 332 into consideration. If the delay risk is high, a higher priority shipping option may be selected 334 to reduce the delay risk. If extra time is available at step 338, the shipment may also be postponed 340 to reduce shipping costs.

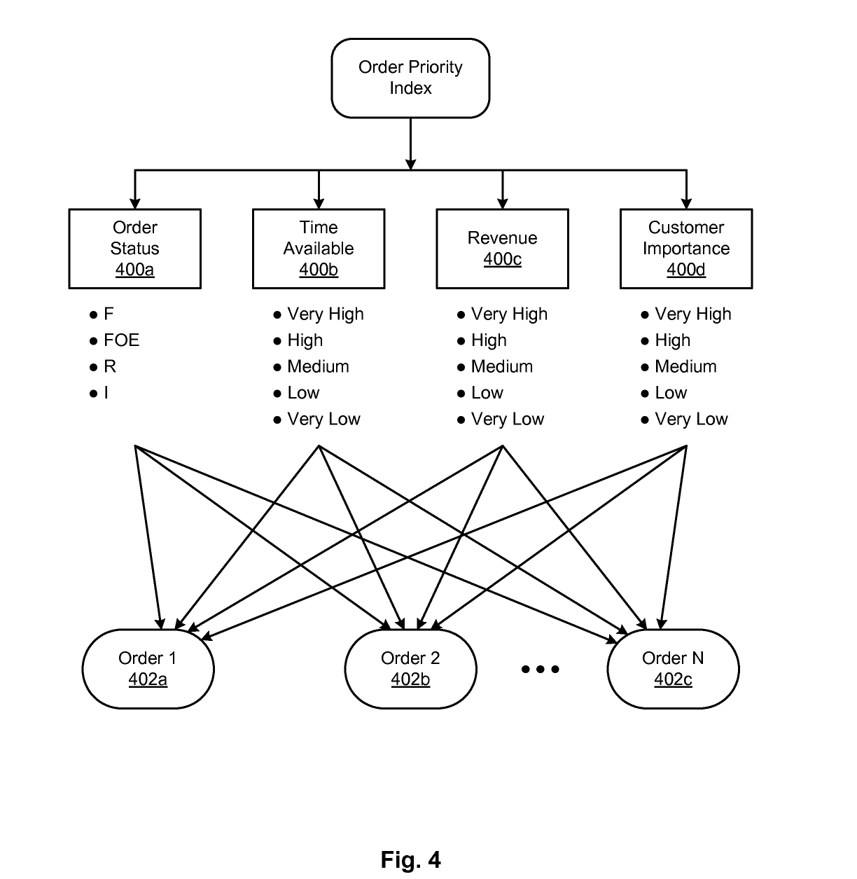

Referring to FIG. 4, while continuing to refer generally to FIG. 3, a high-level block diagram showing an analytic hierarchy process (AHP) for order prioritization is illustrated. The analytic hierarchy process (AHP) is a structured technique for organizing and analyzing complex decisions. This technique may be used to determine priority indexes for customer orders. In this example, criteria used in the AHP process include customer order attributes 400a-d, while alternatives used in the AHP process include customer orders 402a-c. In this example, four main order attributes 400a-d that affect order priority are considered: order status, available time for shipping, revenue, and customer importance. These four attributes 400a-d are compared to one another and assigned scores between one and nine based on relative importance of each attribute 400. The orders 402a-c are then compared to each other for each attribute 400a-d to generate a priority index for each customer order 402.

Referring again to FIG. 3, in certain embodiments, the available time referenced in step 320 may be calculated based on a shipping date of an order, cycle time (i.e., time to build a system being ordered), working days, and time difference between sites according to the following equation:

Available Time=[(Ship Date−Today's Date(Excluding Weekends))±Time Difference]−[Cycle Time]

where the Time Difference refers to a time difference between geographical locations of manufacturing sites (also considering daylight savings time) and the Cycle Time is calculated based on order type and order configuration.

A shipping option for parts may be determined at step 320 by comparing the Available Time to a Transportation Time of the shipping option according to the following equation:

C>Available Time≧Transportation Time(Excluding Weekends)

where Available Time and Transportation Time are in days and C represents a transportation time for the next shipping option.

An example of shipping options for two different countries are shown in Table 1 below (in the table, SLX, SL1, SL2, and SL3 are different shipping options, with SLX being the fastest, most expensive shipping option, and SL3 being the slowest, least expensive shipping option):

TABLE 1
Exemplary Shipping Options for Two Different Countries

| Country A | Country B |
|---|---|
| SLX: 3.3 days > Available Time ≧ | SLX: 3.5 days > Available Time ≧ |
| 3 days (Excluding Weekends) | 2 days |
| SL1: 4.5 days > Available Time ≧ | SL1: 4.5 days > Available Time ≧ |
| 3.3 days (Excluding Weekends) | 3.5 days (Excluding Sundays) |
| SL2: 6.3 days > Available Time ≧ | SL2: 5 days > Available Time ≧ |
| 4.5 days (Excluding Weekends) | 4.5 days (Excluding Weekends) |
| SL3: Available Time ≧ | SL3: Available Time ≧ |
| 6.3 days (Excluding Weekends) | 5 days (Excluding Weekends) |

To determine when parts should be shipped between sites 200, the following equation may be used:

When-to-Ship=[Available Time]−[Transportation Time(Excluding Weekends)]+Today's Date

where [Available Time]−[Transportation Time(Excluding Weekends)]>1. Shipping restrictions may need to be taken into consideration when selecting a shipping option. Some shipping options such as express options that use passenger flights have restrictions with regard to chemicals and shipment height.

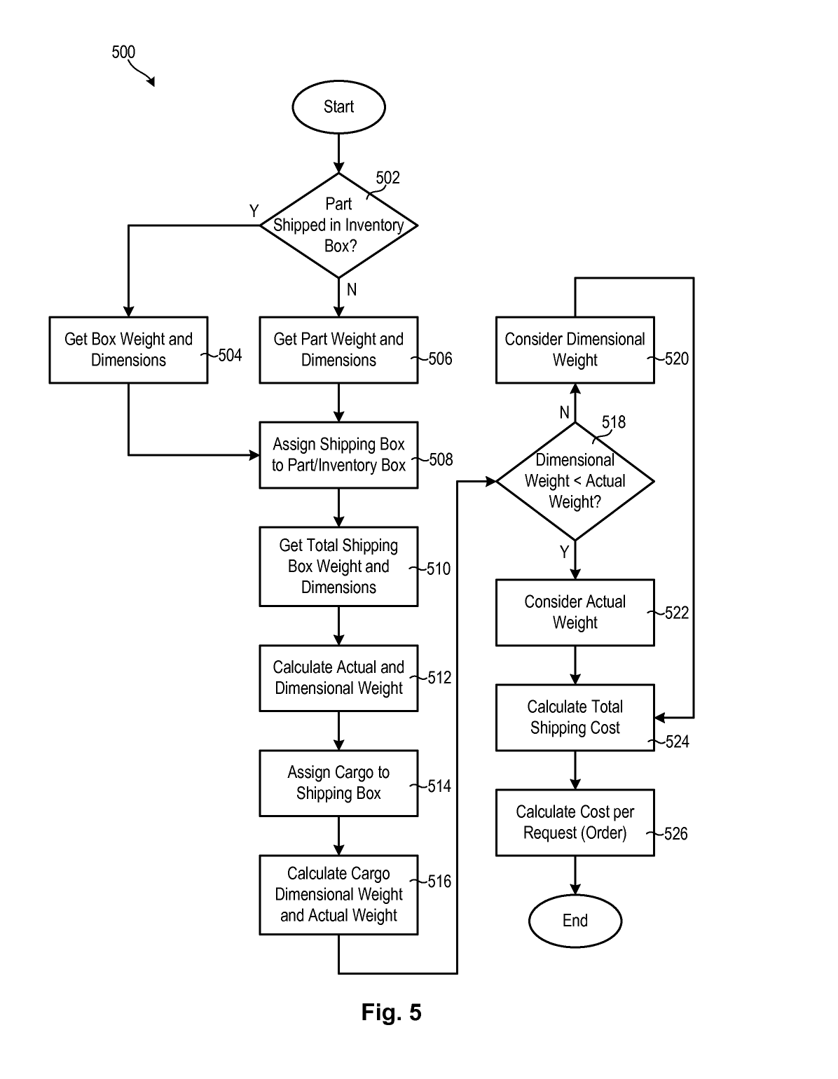

Referring to FIG. 5, while continuing to refer generally to FIG. 3, in order to estimate 322 a shipping cost per order for interplant shipments, a framework 500 such as that illustrated in FIG. 5 may be used. As shown in FIG. 5, the framework 500 initially determines 502 whether a part is to be shipped in an inventory box. If so, the framework 500 retrieves 504 the inventory box weight and dimensions. If not, the framework 500 retrieves 506 the part weight and dimensions. The framework 500 then assigns 508 a shipping box to the part or inventory box and determines 510 a total shipping box weight and dimensions. The framework 500 calculates 512 an “actual” and “dimensional” weight for the shipping box. The “actual” weight may vary in accordance with the mass of an object whereas the “dimensional” weight may vary in accordance with an object's dimension or size. Either (or both) of these measurements may provide a basis for calculating shipping costs.

The framework 500 then assigns 514 cargo to the shipping box and calculates 516 the actual and dimensional weight of the cargo. If, at step 518, the dimensional weight is less than the actual weight, the framework 500 considers 522 the actual weight when calculating 524 total shipping costs. If, however, the dimensional weight is greater than the actual weight, the framework 500 considers 520 the dimensional weight when calculating 524 total shipping costs. Once the total shipping cost is calculated 524, the framework 500 may break down 526 the total shipping cost to determine 526 a cost per order.

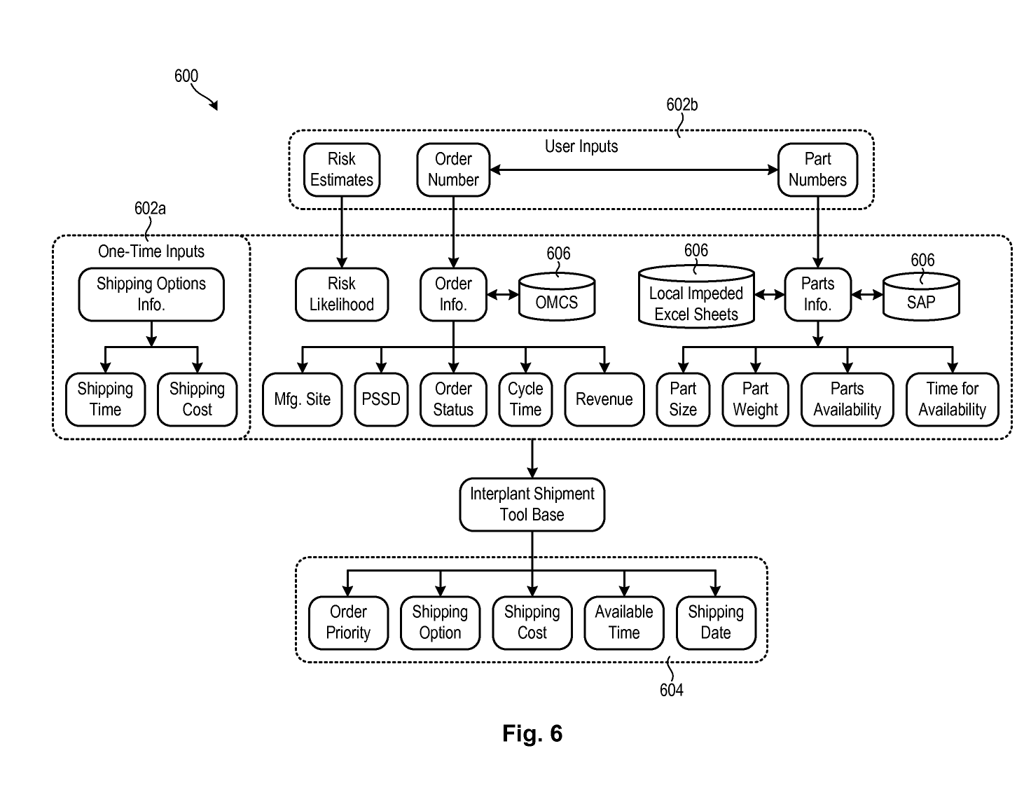

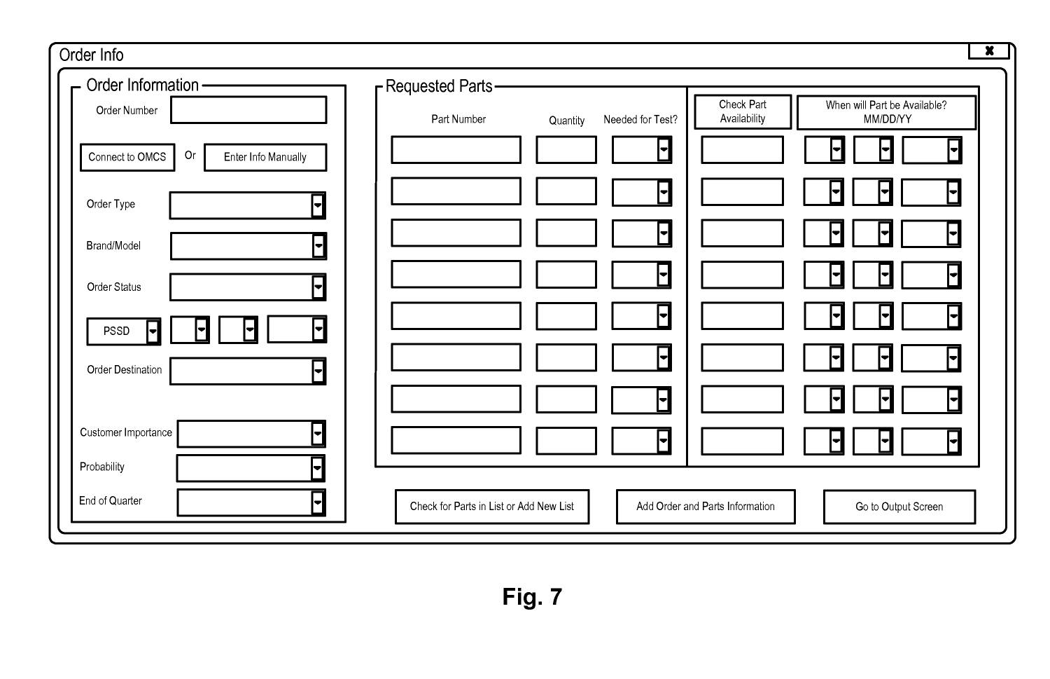

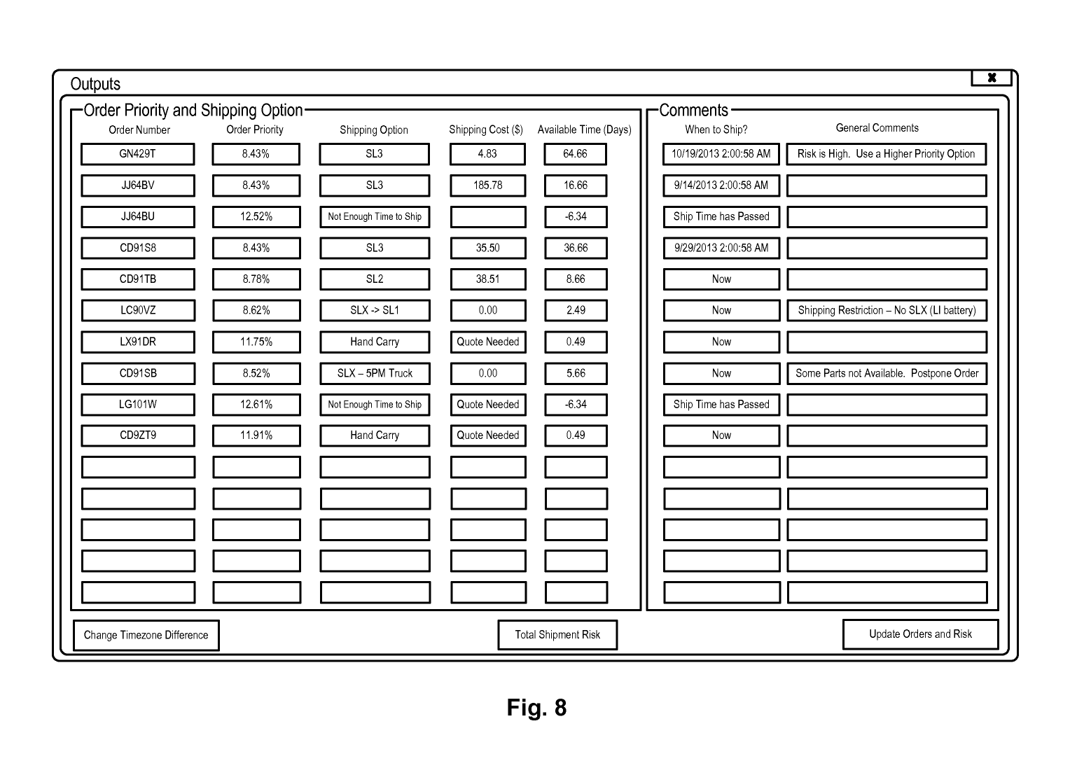

Referring to FIG. 6, in certain embodiments, the framework 300 illustrated in FIG. 3 may be implemented in the form of an interplant transshipment tool 600. An exemplary architecture of such an interplant transshipment tool 600 is illustrated in FIG. 6. In general, the interplant transshipment tool 600 receives various inputs 602 (e.g., user and/or database inputs) and produces one or more outputs 604. Exemplary graphical user interfaces (GUIs) receiving the inputs 602 and displaying the outputs 604 are shown in FIGS. 7 and 8 respectively.

In certain embodiments, inputs 602 to the interplant transshipment tool 600 are divided into two types: (1) one-time inputs 602a which may include, for example, shipping option costs and times, new parts data, and cycle times for different product types; and (2) shipment request inputs 602b such as order numbers and requested part numbers and quantities. FIG. 7 shows one embodiment of a graphical user interface for receiving user input. In certain embodiments, the interplant transshipment tool 600 may be configured to minimize the number of inputs 602 required by the user and only require information such as order numbers, part numbers, and part quantities. Other inputs may be obtained from one or more databases 606. In certain embodiments, in addition to inputting data, a user may check for parts in a database 606 and, if the parts do not exist, the user may have the option to input parts information into the database 606 for future use.

Outputs 604 from the interplant transshipment tool 600 may include the following: order priority, shipping options, shipping costs, available time, part ship dates, and comments. FIG. 8 shows one embodiment of a graphical user interface for providing such outputs. For each order, the interplant transshipment tool 600 may evaluate the order's priority so that parts may be assigned to orders based on priority. The interplant transshipment tool 600 may also estimate a shipping option and corresponding costs for each order. In order to avoid or mitigate order cancellation risk, the interplant transshipment tool 600 may suggest dates for shipping parts when extra time is available. As shown in FIG. 8, a comments column may be used to inform a user when or why a particular decision has been made. For example, if a shipping option for an order has been changed from SLX to SL1, a comments field may indicate that the change was made as a result of a shipping restriction on the requested part. The output screen illustrated in FIG. 8 may also enable a user to modify or update order information, change a time zone difference, add a transportation risk, or the like.

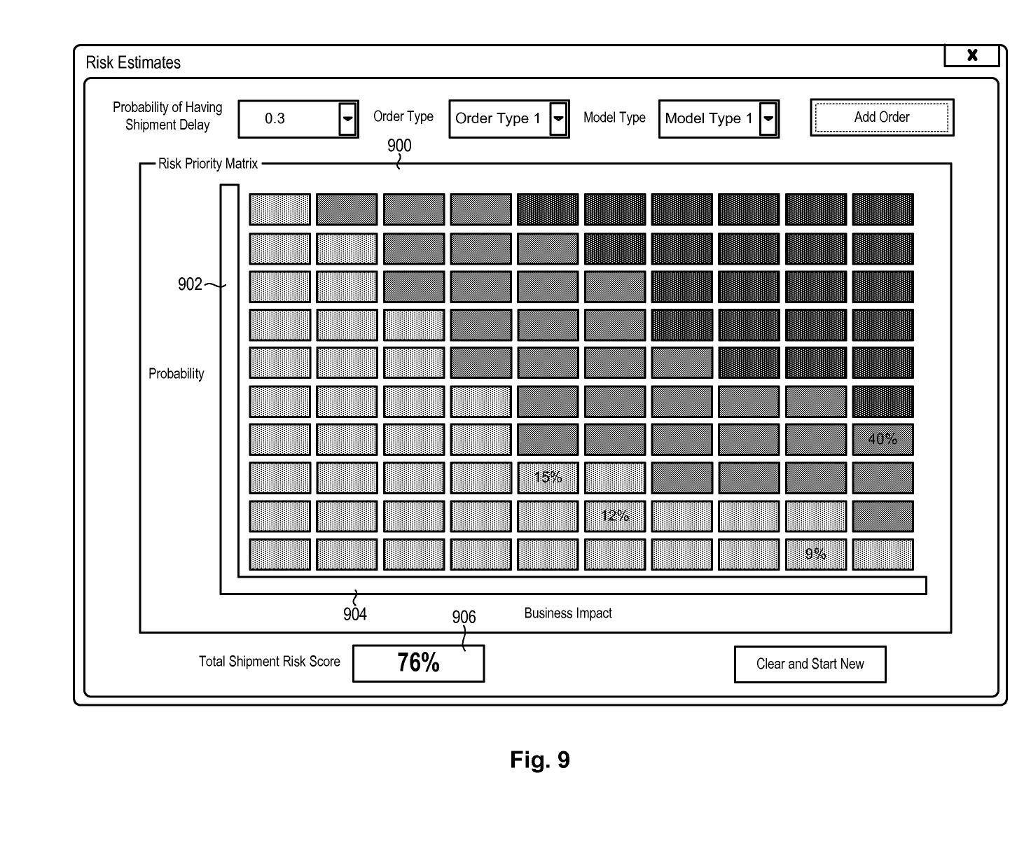

Referring to FIG. 9, the interplant transshipment tool 600 may estimate transportation risk (also known as infrastructure risk) when a shipping option is selected. In certain embodiments, the transportation risk associated with an order is based on a probability that the shipping option will result in a delay of the order, and an amount of revenue that will be affected or impacted as a result of the delay. In certain embodiments, the transportation risk may be displayed in a matrix-like structure 900 that enables a user to visually understand the transportation risk. The position of a transportation risk value in the matrix 900 may be based on a probability that a shipping option will result in a delay of an order, and an amount of revenue that will be affected or impacted as a result of the delay. For example, as shown in FIG. 9, the vertical position 902 of the transportation risk may be based on a probability that the shipping option will result in a delay of the order, whereas a horizontal position 904 of the transportation risk within the matrix 900 may be based on business impact, which may be expressed as an amount of revenue that will be affected or impacted as a result of the delay. In this example, each transportation risk value is expressed as a percentage arrived at by multiplying the probability and the business impact.

If a shipment includes multiple orders, the transportation risk for each order may be simultaneously displayed in the matrix 900, as shown in FIG. 9 (the 15%, 12%, 9%, and 40% values in the matrix 900 are each transportation risk values for different orders). In certain embodiments, a total shipment risk score 906 may be displayed for all the orders. This total shipment risk score 906 may, in certain embodiments, be calculated by summing the transportation risk values for each of the orders in the shipment. If a transportation risk value or total shipment risk score 906 is not acceptable, a user may alter a shipping option to bring the transportation risk to within an acceptable level. Altering the shipping option may change the transportation risk for each order (there altering their position in the matrix) as well as the total shipment risk score 906. In certain embodiments, the matrix may be updated automatically upon modifying a shipping option for a particular order or shipment.

In certain embodiments, the matrix may be color coded (or shaded as shown in FIG. 9) to show the severity of a transportation risk value. For example, transportation risk values that are acceptable may be green or have a green background, transportation risk values that are not acceptable may be red or have a red background, and transportation risk values that are borderline unacceptable may be yellow or have a yellow background. In this way, a user may quickly see or identify transportation risk values that are unacceptable or borderline unacceptable so that the user can select a different shipping option and thereby bring the transportation risk values within an acceptable level. For the purposes of this disclosure, a “matrix” or “matrix-like structure” is used broadly to encompass other types of graphs or displays for visualizing transportation risk values.

The block diagrams in the Figures illustrate the architecture, functionality, and operation of possible implementations of systems, methods, and computer-usable storage media according to various embodiments of the present invention. In this regard, each block in the block diagrams may represent a module, segment, or portion of code, which comprises one or more executable instructions for implementing the specified logical function(s). It should also be noted that, in some alternative implementations, the functions discussed in association with a block may occur in a different order than discussed. For example, two functions occurring in succession may, in fact, be implemented in the reverse order, depending upon the functionality involved. It will also be noted that each block of the block diagrams, and combinations of blocks in the block diagrams, may be implemented by special purpose hardware-based systems that perform the specified functions or acts, or combinations of special purpose hardware and computer instructions.

1. A method for enabling enhanced decision-making when shipping parts between sites within an organization, the method comprising:
receiving a plurality of orders to deliver parts from a first site to a second site;
determining a shipping option for shipping the parts from the first site to the second site;
determining, for each of the orders, a transportation risk associated with the shipping option, the transportation risk varying in accordance with a probability that the shipping option will result in a delay, and an amount of revenue that will be affected as a result of the delay;
displaying, in a matrix, the transportation risk for each of the orders, wherein the position of each transportation risk within the matrix is based on the probability that the shipping option will result in a delay, and the amount of revenue that will be affected as a result of the delay; and
enabling a user to modify the shipping option to adjust the position of each transportation risk within the matrix.

2. The method of claim 1, further comprising determining whether a cost to ship parts from the first site to the second site exceeds a cost to build a product at the first site and ship the product directly to a customer.

3. The method of claim 2, further comprising, in the event the cost to ship the parts from the first site to the second site exceeds the cost to build the product at the first site and ship the product directly to the customer, offloading an order associated with the product from the second site to the first site.

4. The method of claim 2, further comprising, in the event the cost to ship the parts from the first site to the second site exceeds the cost to build the product at the first site and ship the product directly to the customer, determining whether a due date of an order associated with the product may be changed.

5. The method of claim 4, further comprising postponing the due date in the event the due date may be changed.

6. The method of claim 1, wherein determining the shipping option further comprises calculating an available time to ship the parts.

7. The method of claim 1, further comprising summing the transportation risks to provide a total transportation risk score for the plurality of orders.

8. A computer program product for enabling enhanced decision-making when shipping parts between sites within an organization, the computer program product comprising a computer-readable storage medium having computer-usable program code embodied therein, the computer-usable program code comprising:
computer-usable program code to receive a plurality of orders to deliver parts from a first site to a second site;
computer-usable program code to determine a shipping option for shipping the parts from the first site to the second site;
computer-usable program code to determine, for each of the orders, a transportation risk associated with the shipping option, the transportation risk varying in accordance with a probability that the shipping option will result in a delay, and an amount of revenue that will be affected as a result of the delay;
computer-usable program code to display, in a matrix, the transportation risk for each of the orders, wherein the position of each transportation risk within the matrix is based on the probability that the shipping option will result in a delay, and the amount of revenue that will be affected as a result of the delay; and
computer-usable program code to enable a user to modify the shipping option to adjust the position of each transportation risk within the matrix.

9. The computer program product of claim 8, further comprising computer-usable program code to determine whether a cost to ship parts from the first site to the second site exceeds a cost to build a product at the first site and ship the product directly to a customer.

10. The computer program product of claim 9, further comprising computer-usable program code to, in the event the cost to ship the parts from the first site to the second site exceeds the cost to build the product at the first site and ship the product directly to the customer, offload an order associated with the product from the second site to the first site.

11. The computer program product of claim 9, further comprising computer-usable program code to, in the event the cost to ship the parts from the first site to the second site exceeds the cost to build the product at the first site and ship the product directly to the customer, determine whether a due date of an order associated with the product may be changed.

12. The computer program product of claim 11, further comprising computer-usable program code to postpone the due date in the event the due date may be changed.

13. The computer program product of claim 8, wherein determining the shipping option further comprises calculating an available time to ship the parts.

14. The computer program product of claim 8, further comprising computer-usable program code to sum the transportation risks to provide a total transportation risk score for the plurality of orders.

15. An apparatus for enabling enhanced decision-making when shipping parts between sites within an organization, the apparatus comprising:
at least one processor;
at least one memory device coupled to the at least one processor and storing computer instructions to cause the at least one processor to:
receive a plurality of orders to deliver parts from a first site to a second site;
determine a shipping option for shipping the parts from the first site to the second site;
determine, for each of the orders, a transportation risk associated with the shipping option, the transportation risk varying in accordance with a probability that the shipping option will result in a delay, and an amount of revenue that will be affected as a result of the delay;
display, in a matrix, the transportation risk for each of the orders, wherein the position of each transportation risk within the matrix is based on the probability that the shipping option will result in a delay, and the amount of revenue that will be affected as a result of the delay; and
enable a user to modify the shipping option to adjust the position of each transportation risk within the matrix.

16. The apparatus of claim 15, wherein the computer instructions further cause the at least one processor to determine whether a cost to ship parts from the first site to the second site exceeds a cost to build a product at the first site and ship the product directly to a customer.

17. The apparatus of claim 16, wherein the computer instructions further cause the at least one processor to, in the event the cost to ship the parts from the first site to the second site exceeds the cost to build the product at the first site and ship the product directly to the customer, offload an order associated with the product from the second site to the first site.

18. The apparatus of claim 16, wherein the computer instructions further cause the at least one processor to, in the event the cost to ship the parts from the first site to the second site exceeds the cost to build the product at the first site and ship the product directly to the customer, determine whether a due date of an order associated with the product may be changed.

19. The apparatus of claim 18, wherein the computer instructions further cause the at least one processor to postpone the due date in the event the due date may be changed.

20. The apparatus of claim 15, wherein determining the shipping option further comprises calculating an available time to ship the parts and selecting a lowest cost shipping option capable of delivering the parts to the second site within the available time.
